(19) United States
(12) Patent Application Publication
(10) Pub. No.: US 2007/0220450 A1
(43) Pub. Date: Sep. 20, 2007

(54) Computer-executable circuit drawing file integration interface and system thereof

(75) Inventor: Ming-Hui Lin, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/377,202

(22) Filed: Mar. 17, 2006

(51) Int. Cl. G06F 17/50

(52) U.S. Cl. 716/1

(57) ABSTRACT

A computer-executable circuit drawing file integration interface and system thereof is provided. The interface and system are used to merge more than one circuit drawing file into a consolidated circuit drawing file. The interface comprises a first file selection window, used to enable the user to select and preview the circuit drawing files to be merged; a second file selection window, used to enable the user to select and preview the next circuit drawing file to be merged; a file accumulation press key, used to enable the user to add the next circuit drawing file to be merged into the first or second file selection windows; and a file merging press key, used to integrate the circuit drawing file selected by the user and the circuit drawing file to be merged into a consolidated circuit drawing file.

### BACKGROUND OF THE INVENTION

1. Field of the Invention

The invention relates to a file integration interface and system thereof, in particular to a computer-executable circuit drawing file integration interface and a system thereof.

2. Related Art

In the past, the sketching of the electronic circuit drawings is done by a single electronic engineer assigned for the specific case. However, nowadays, the sketching of the drawings of the electronic circuits is done by several engineers simultaneously with the purpose and in line with the tendency of shortening the time spent on research and development. And in the final stage, the drawings done by each of the respective engineers are put together and integrated into the final and complete version as required. As such, through the division of work, the time spent on sketching the electronic circuit drawings is shortened, thus the time spent on research and development is reduced significantly.

Since there are only slight differences between the respective electronic circuit drawing, and the major frameworks of the respective circuits are quite similar, thus in sketching the circuit drawings, only part of the circuits or some of the electronic elements have to be added or replaced. Then the files of the respective circuit drawings are integrated/merged together into a final and complete drawing file. Refer to FIG. 1 for the steps of a process flow of integrating the ordinary circuit drawing files. Firstly, execute sketch-drawing software (for example, the Board Architect drawing-sketching software) (step 100). Next, create a new drawing file (step 101), and open the files to be merged (step 102). Then, select all of the files to be merged (step 103). Subsequently, copy the files to be merged and integrated into a new file (step 104). Then, check to see if the newly merged file is correct and complete (step 105), and if the answer if affirmative, save the merged file into the storage device (step 106). Finally, determine if the present file is the last file to be processed (step 107), if the answer is affirmative, then the file-merging process is completed (step 108), otherwise go back to step 101 to continue the file-merging process.

In the above-mentioned process, each of the respective steps is processed manually by the user. When the number of files is small, the user may be able to cope with handling each of the files sequentially. However, when the number of the files becomes large, the time and manpower spent on merging the files could be quite enormous, that is not in compatible with the tendency of reducing the time spent on research and development.

Therefore, the research and development of a computer-executable circuit drawing files integration interface and a system thereof, which can be used to simplify and streamline the circuit drawing file integration process, is the most urgent task in this field.

### SUMMARY OF THE INVENTION

In view of the above-mentioned problems and shortcomings of the prior art, the object of the invention is to provide a computer-executable circuit drawing file integration interface and system thereof, which is capable of providing the increased operation efficiency and convenience through the simplified graphic operation interface, so that the user may be able to merge the circuit drawing files at faster speed.

Therefore, to achieve the above-mentioned object, the invention discloses a computer-executable circuit drawing file integration interface which can be utilized to merge more than one circuit drawing files into one consolidated circuit drawing file, including: a first file selection window, a second file selection window, a file accumulation press key, and a file merge press key. The details of each of the respective elements are described as follows.

The first file selection window is used to provide the user the capability to select and preview the contents of circuit drawing files to be merged, in which the right edge and bottom edge of the first file selection window are provided with a vertical scrolling axis and a lateral scrolling axis respectively, so that the user can scroll the first file selection window vertically or horizontally.

The second file selection window is used to provide the user the capability to select and preview the contents of circuit drawing files to be merged, wherein, the right edge and bottom edge of the second file selection window are provided with a vertical scrolling axis and a lateral scrolling axis respectively, so that the user can scroll the second file selection window vertically or horizontally.

The file accumulation press key is used to enable the user to add a circuit drawing file to be merged into the first or second file selection window.

The file merging press key is used to provide the user the capability to merge the selected circuit drawing files and the circuit drawing files to be merged into a consolidated new circuit drawing file.

In addition, a file deletion press key is provided to enable the user to delete any selected circuit drawing file.

To achieve the above-mentioned object, the invention discloses a computer-executable circuit drawing file integration system which can be utilized to merge more than one circuit drawing file into one consolidated circuit drawing file, including: a circuit drawing file selection unit, a circuit drawing file preview unit, a circuit drawing file integration unit, and a circuit drawing database. The details of each of the respective units will be described as follows.

The circuit drawing file selection unit is used to select the respective circuit drawing files desired to be merged.

The circuit drawing file preview unit is used to open and preview each selected circuit drawing file.

The circuit drawing file integration unit is used to merge the selected respective circuit drawing files into a consolidated circuit drawing file, and then store the merged circuit drawing file thus created into the circuit drawing database.

The circuit drawing data base is used to store the circuit drawing files to be merged and the merged circuit drawing file.

Through the application of the computer-executable circuit drawing file integration interface and system of the invention, the user is enabled to select all the circuit drawing files to be merged only once, then execute the file-merging operation to achieve the purpose of file-merging, thus simplifying the operation process of circuit drawing files merging and raise the efficiency and convenience of the file-merging, thereby reducing the time spent on the research and development.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention.

FIG. 1 is a conventional system flow chart of the steps of the circuit drawing file merging;

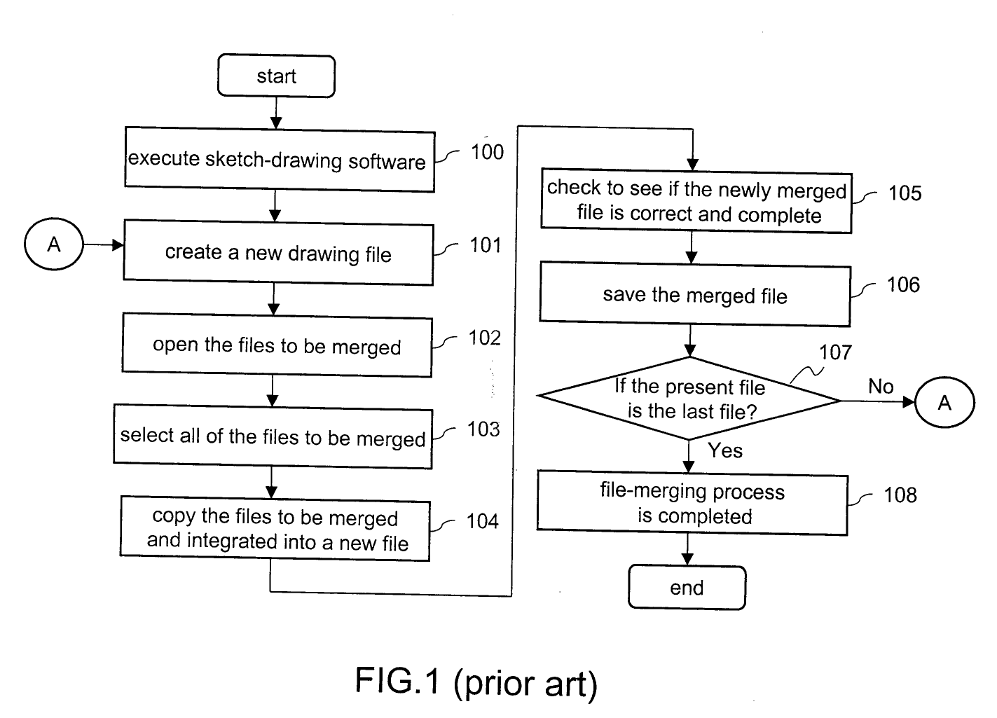

FIG. 2 is a system block diagram of the computer-executable circuit drawing file integration interface system according to an embodiment of the invention; and

FIG. 3 is a schematic diagram of the computer-executable circuit drawing file integration interface according to an embodiment of the invention.

### DETAILED DESCRIPTION OF THE INVENTION

The purpose, construction, features, and functions of the invention can be appreciated and understood more thoroughly through the following detailed description with reference to the attached drawings.

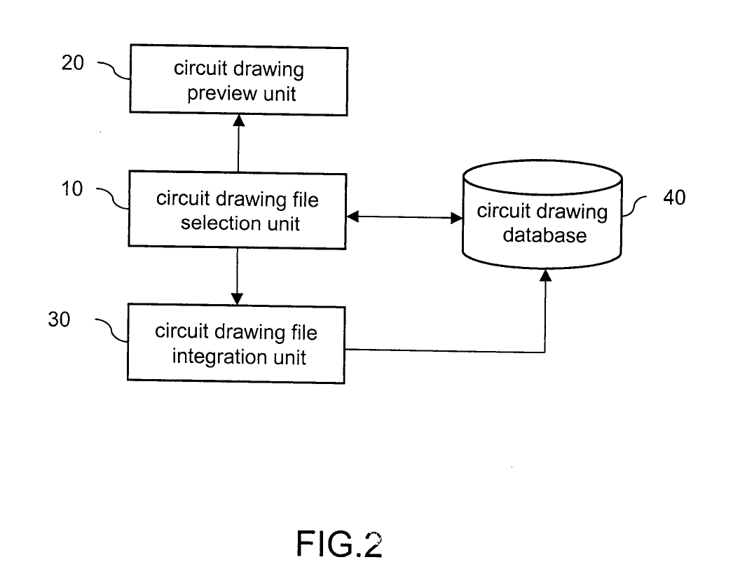

Refer to FIG. 2 for a system block diagram of the computer-executable circuit drawing file integration interface system according to an embodiment of the invention, The system includes a circuit drawing file selection unit 10, a circuit drawing preview unit 20, a circuit drawing file integration unit 30, and a circuit drawing database 40. The details of each of the respective units will be described as follows.

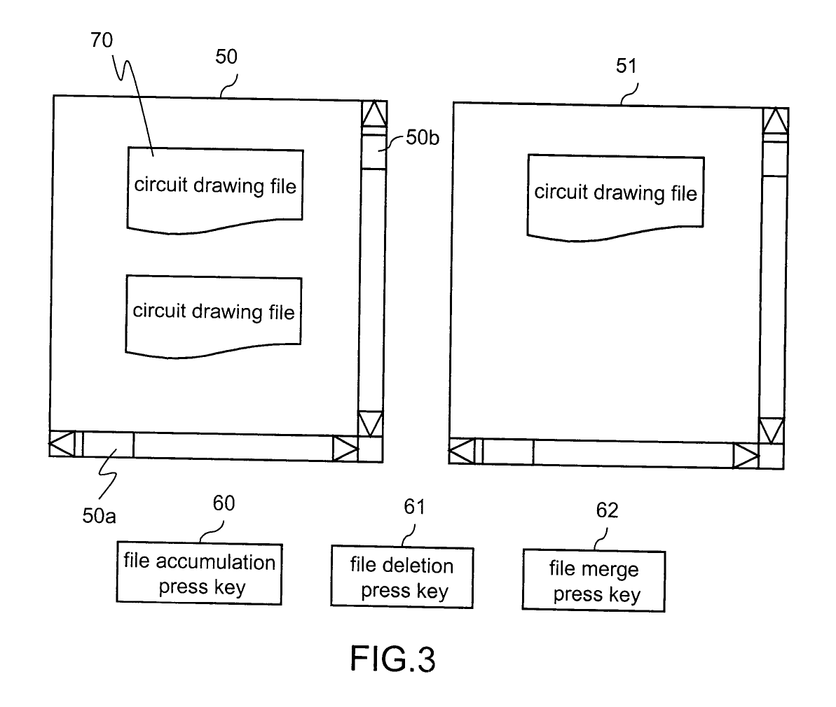

The circuit drawing file selection unit 10 selects the circuit drawing files to be merged from the circuit drawing database 40 according to the selection instruction generated by the file integration operation interface (as shown in FIG. 3) for proceeding with the circuit drawing file integration process. Wherein, the selection made by the circuit drawing file selection unit 10 may be one file per selection or several files per selection, then the selected files are transmitted to the circuit drawing preview unit 20 and the circuit drawing file integration unit 30.

The circuit drawing preview unit 20 connects to the circuit drawing file selection unit 10 for opening and displaying the contents of the selected circuit drawing file in the file selection window of the file integration operation interface, so that the user may verify that whether the selected circuit drawing file is correct.

The circuit drawing file integration unit 30 connects to the circuit drawing file selection unit 10 for merging the selected circuit drawing files and then storing the merged file into the circuit drawing database 40. In the above process, the circuit drawing file integration unit 30 is utilized to copy the contents of the respective files to be merged and incorporate them into a new circuit drawing file.

The circuit drawing database 40 connects respectively to the circuit drawing file selection unit 10 and the circuit drawing file integration unit 30, thus providing a data storage area for storing the sketched and merged circuit drawing files, and enabling the circuit drawing file selection unit 10 to read the circuit drawing files to be merged. Next, refer to FIG. 3 for a schematic diagram of the computer-executable circuit drawing file integration interface according to an embodiment of the invention, the interface includes a first file selection window 50, a second file selection window 51, a file accumulation press key 60, a file deletion press key 61, and a file merging press key 62. The details of each of the respective elements are described as follows.

The first file selection window 50 is used to provide the user the capability to select and preview the contents of the circuit drawing file 70 to be merged, so that the user can verify whether the selected circuit drawing file 70 is correct.

The second file selection window 51 is used to provide the user the capability to select and preview the contents of the circuit drawing file 70 to be merged, so that the user can verify whether the selected circuit drawing file 70 is correct.

The lateral scrolling axis 50a and the vertical scrolling axis 50b are disposed respectively on the lower and right edges of the first file selection window 50 and the second file selection window 51, which can be moved horizontally or vertically so that the user can scroll and view the file selection windows to select and preview the circuit drawing file 70.

The file accumulation press key 60 is used to enable the user to add the next circuit drawing file 70 to be merged to the file in the first file selection window 50 or the second file selection window 51. Upon the user clicking the file accumulation press key 60, the file selection route window is displayed (not shown), so that the user is able to select the next circuit drawing file 70 to be merged according to its access route.

The file deletion press key 61 is used to enable the user to delete any selected circuit drawing file 70, so that the user may re-select the next circuit drawing file 70 to be merged. The steps are the user first selects the circuit drawing file 70 to be merged in the first file selection window 50 or the second file selection window 51, and then clicks the file deletion press key 61 to implement the deletion of the selected circuit drawing file 70.

After the user finishes the selection, the file merging press key 62 is used to enable the user to merge the selected circuit drawing file 70 into these circuit drawing file 70 to be merged into a consolidated circuit drawing file.

In addition, in the embodiment of the invention, a plurality of file selection windows may be provided instead of two, so as to expedite the opening and preview of the circuit drawing file. As such, the number of the first file selection window and second file selection window is not intended to limit the number of file selection window that can be used in the invention.

Through the application of the computer-executable circuit drawing file integration interface of the invention, the circuit drawing files to be merged may be chosen in only one selection, then execute the file-merging operation to achieve the purpose of file-merging, thus simplifying the operation process of circuit drawing files merging and raising the efficiency and convenience of file-merging, thereby reducing the time spent on the research and development.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer-executable circuit drawing file integration interface, which is used to merge more than one circuit drawing file into a consolidated circuit drawing file, comprising:
a first file selection window, used to enable the user to select and preview the circuit drawing files to be merged;
a second file selection window, used to enable the user to select and preview the next circuit drawing file to be merged;
a file accumulation press key, used to enable the user to add the next circuit drawing file to be merged into the first or second file selection windows; and
a file merging press key, used to integrate the circuit drawing file selected by the user and the circuit drawing file to be merged into a consolidated circuit drawing file.

2. The computer-executable circuit drawing file integration interface as claimed in claim 1, further comprising:
a file deletion press key, used to enable the user to delete the selected circuit drawing file.

3. The computer-executable circuit drawing file integration interface as claimed in claim 1, wherein two sides of the first file selection window are provided with a vertical scrolling axis and a lateral scrolling axis, so that the user can scroll the first file selection window vertically or horizontally.

4. The computer-executable circuit drawing file integration interface as claimed in claim 1, wherein two sides of the second file selection window are provided with a vertical scrolling axis and a lateral scrolling axis, so that the user can scroll the second file selection window vertically or horizontally.

5. A computer-executable circuit drawing file integration system, which is used to merge more than one circuit drawing file into a consolidated circuit drawing file, comprising:
a circuit drawing file selection unit, used to select the respective circuit drawing files to be merged;
a circuit drawing file preview unit, used to open and preview the respective circuit drawing files;
a circuit drawing file integration unit, used to integrate the respective circuit drawing files into a consolidated circuit drawing file; and
a circuit drawing database, used to store the circuit drawing files to be merged and the merged circuit drawing files.

6. The computer-executable circuit drawing file integration system as claimed in claim 5, wherein the circuit drawing file integration unit is used to store the merged circuit drawing file into the circuit drawing database.
